(19) United States
(12) Patent Application Publication
(10) Pub. No.: US 2021/0398086 A1
(43) Pub. Date: Dec. 23, 2021

(54) MAINTENANCE WORK SUPPORT APPARATUS, MAINTENANCE WORK SUPPORT SYSTEM, MAINTENANCE WORK SUPPORT METHOD, AND MAINTENANCE WORK SUPPORT PROGRAM

(71) Applicant: Broadieaf Co., Ltd., Tokyo (JP)

(72) Inventors: Yuichiro TANIGUCHI, Tokyo (JP); Kazunarl KODAMA, Tokyo (JP); Daichi YAMADA, Tokyo (JP); Masami ENOKIDA, Tokyo (JP)

(21) Appl. No.: 17/279,815

(22) PCT Filed: Sep. 27, 2019
(86) PCT No.: PCT/JP2019/038402

§ 371 Date: Mar. 25, 2021

(30) Foreign Application Priority Data
Sep. 28, 2018 (JP) 2018-184358

(51) Int. Cl. G06Q 10/00; G06F 3/0484; G06F 3/0482

(52) U.S. Cl. CPC G06Q 10/20; G06F 3/0482; G06F 3/04847

(57) ABSTRACT

There are provided a maintenance work support apparatus, a maintenance work support system, a maintenance work support method, and a maintenance work support program capable of reflecting various conditions, regional differences, or price fluctuations. In a maintenance work support process, a server 1 causes an information terminal 2 to display a company information setting screen, causes the information terminal 2 to display an accounting information setting screen, and causes the information terminal 2 to display a holiday information setting screen. A user company information setting screen is displayed on the information terminal 2, and a transfer account information setting screen is displayed on the information terminal 2. A labor rate setting screen is displayed on the information terminal 2, a work price setting screen is displayed on the information terminal 2, a part price setting screen is displayed on the information terminal 2, and the process ends.

### TECHNICAL FIELD

The present invention relates to a maintenance work support apparatus, a maintenance work support system, a maintenance work support method, and a maintenance work support program, and in particular, to a maintenance work support apparatus, a maintenance work support system, a maintenance work support method, and a maintenance work support program for setting prices and other various conditions according to user attributes in the initial settings.

### BACKGROUND ART

In general, there is a vehicle inspection system to ensure the safe driving of vehicles by making regular inspections of vehicles mandatory. Vehicle inspection is to inspect that there is no problem in appearance, safety, or pollution based on the safety standards established by the Ministry of Land, Infrastructure, Transport and Tourism. For example, for automobiles, it is necessary to inspect the condition of automobiles once every two years at the Transportation Bureau or the designated shop for vehicle inspection and maintenance approved by the Transportation Bureau. Then, a vehicle verification that is valid for two years is issued or renewed for automobiles that have passed the inspection.

In addition, regular inspection and maintenance of automobiles are carried out before undergoing vehicle inspections. In general, regular inspection and maintenance of automobiles are carried out at automobile maintenance shops or automobile dealers (dealers). Among these, there are automobile maintenance shops approved as designated shops for vehicle inspection and maintenance, and in many cases, regular inspection and maintenance and vehicle inspection are carried out as a set.

In the above-described vehicle inspection or regular inspection and maintenance, reception, warehousing, pick-up, substitute vehicle rental, quotation, work, document preparation, vehicle delivery, substitute vehicle collection, and the work of automobile maintenance shops and the like are very complicated. In particular, as for the work description, for example, in the case of 24-month inspection, there are 56 inspection items, and it is necessary to accurately manage whether or not to carry out inspection for each item, which is very troublesome for automobile maintenance shops and the like.

For this reason, various systems for supporting these works and reducing the labor of automobile maintenance shops and the like have been conventionally developed and widely used in automobile maintenance shops and the like.

For example, PATENT LITERATURE 1 discloses a vehicle maintenance information management system that allows vehicle maintenance information and the like to be easily and smoothly browsed and managed even if a user is unfamiliar with computer operations, so that the maintenance information and the like can be fully utilized, and that can present sufficient information to customers regardless of whether the user has a lot of expertise in maintenance or not.

In addition, PATENT LITERATURE 2 discloses a vehicle maintenance information management system for storing the vehicle number related to a vehicle, owner and user information of the vehicle, and the service content including maintenance at each store and information provision of used cars and transmitting the stored information to the customer and for simplifying the accounting process at each store.

### CITATION LIST

### Patent Literature

PATENT LITERATURE 1: JP 2018-120564 A
PATENT LITERATURE 2: JP 2018-092630 A

### SUMMARY OF INVENTION

### Technical Problem

However, the inspection items listed in the designated maintenance record book are common regardless of the jurisdiction area of an automobile maintenance shop (transportation branch office or automobile inspection and registration office) based on the laws and regulations established by the Ministry of Land, Infrastructure, Transport and Tourism. On the other hand, for the entry form of inspection results for inspection items, a unique entry form different for each jurisdiction area is adopted in accordance with the laws and regulations established by the Ministry of Land, Infrastructure, Transport and Tourism. In addition, there are regional differences in the amount of money required for vehicle inspections or regular inspection and maintenance (the amount of money charged by automobile maintenance shops to customers for vehicle inspections and regular inspection and maintenance), and price fluctuations may occur depending on the time of year.

Therefore, when introducing a system such as PATENT LITERATURE 1 or PATENT LITERATURE 2, it is necessary for each automobile maintenance shop or the like to make initial setting according to the area or time, but the setting items are complicated and diverse, and some items are difficult to input. For this reason, it is actually difficult for the automobile maintenance shop or the like, which is a user, to set various conditions by itself. In practice, at the time of system introduction, a serviceman (person in charge) of the maker for manufacturing and sales (hereinafter, simply maker) of the system goes directly to each automobile maintenance shop or the like and makes initial setting. In particular, there are regional differences and price fluctuations in the amount of money, but it is not possible to set the accurate amount of money because each automobile maintenance shop or the like cannot grasp the market price. As a result, as a maker, extra labor or labor costs are incurred, and that amount is added to the price of the system itself, which is disadvantageous to both the maker and the automobile maintenance shop.

Therefore, the present invention has been made in view of the aforementioned problems, and it is an object of the present invention to provide a maintenance work support apparatus, a maintenance work support system, a maintenance work support method, and a maintenance work support program capable of reflecting various conditions, regional differences, or price fluctuations according to user attributes so that the user can easily perform initial setting by himself or herself.

### Solution To Problem

In order to solve the aforementioned problems, a maintenance work support apparatus of the present invention is a maintenance work support apparatus for supporting maintenance work of a vehicle or a part of an automobile. The maintenance work support apparatus includes: a storage unit that stores a jurisdiction area corresponding to attributes of a user and an application document format for each jurisdiction area; a display control unit that displays a setting screen including initial setting items; a reception unit that receives an input operation of the user on the setting screen; and an initial setting unit that selects the jurisdiction area according to the input operation of the user received by the reception unit and performs initial setting for each user. The display control unit interactively displays the initial setting items to instruct the user to perform input operations in a predetermined order.

In addition, in order to solve the aforementioned problems, a maintenance work support system of the present invention is a maintenance work support system for supporting maintenance work of a vehicle or a part of an automobile. The maintenance work support system includes: a server; and an information terminal communicatively connected to the server. The server or the information terminal includes: a storage unit that stores a jurisdiction area corresponding to attributes of a user and an application document format for each jurisdiction area; a display control unit that displays a setting screen including initial setting items; a reception unit that receives an input operation of the user on the setting screen; and an initial setting unit that selects the jurisdiction area according to the input operation of the user received by the reception unit and performs initial setting for each user. The display control unit interactively displays the initial setting items to instruct the user to perform input operations in a predetermined order.

In addition, in order to solve the aforementioned problems, a maintenance work support method of the present invention is a maintenance work support method for supporting maintenance work of a vehicle or a part of an automobile by a computer. The maintenance work support method includes: a storage step in which the computer stores a jurisdiction area corresponding to attributes of a user and an application document format for each jurisdiction area; a display control step in which the computer displays a setting screen including initial setting items; a reception step in which the computer receives an input operation of the user on the setting screen; and an initial setting step in which the computer selects the jurisdiction area according to the input operation of the user received in the reception step and performs initial setting for each user. In the display control step, the initial setting items are interactively displayed to instruct the user to perform input operations in a predetermined order.

In addition, in order to solve the aforementioned problems, a maintenance work support program of the present invention is a maintenance work support program for supporting maintenance work of a vehicle or a part of an automobile. The maintenance work support program causes a computer to function as: a storage unit that stores a jurisdiction area corresponding to attributes of a user and an application document format for each jurisdiction area; a display control unit that displays a setting screen including initial setting items; a reception unit that receives an input operation of the user on the setting screen; and an initial setting unit that selects the jurisdiction area according to the input operation of the user received by the reception unit and performs initial setting for each user. The display control unit interactively displays the initial setting items to instruct the user to perform input operations in a predetermined order.

In the maintenance work support apparatus, the maintenance work support system, the maintenance work support method, and the maintenance work support program of the present invention configured as described above, the initial setting items are displayed interactively (wizard format) on the initial setting screen to instruct the user to perform input operations in the predetermined order. Therefore, for the entry form of inspection results for inspection items, a unique entry form different for each jurisdiction area (transportation branch office or automobile inspection and registration office) is adopted, and these need to be set for each user. In the present invention, however, a user can easily input and set a wide variety of complicated initial setting items by himself or herself. In addition, this makes it possible to save the trouble of having an expert go directly to each automobile maintenance shop or the like and make initial setting when introducing the system.

In addition, in order to solve the aforementioned problems, the maintenance work support apparatus of the present invention further includes: an amount collection unit that collects information regarding an amount of money presented to a customer by the user as a cost of the maintenance work; and an amount counting unit that counts the information regarding the amount of money collected by the amount collection unit for each jurisdiction area. The storage unit stores the information regarding the amount of money counted by the amount counting unit as a reference amount for each jurisdiction area applied at the time of the initial setting, and the display control unit displays the reference amount on the setting screen.

In addition, in order to solve the aforementioned problems, according to the maintenance work support system of the present invention, the server or the information terminal further includes: an amount collection unit that collects information regarding an amount of money presented to a customer by the user as a cost of the maintenance work; and an amount counting unit that counts the information regarding the amount of money collected by the amount collection unit for each jurisdiction area. The storage unit stores the information regarding the amount of money counted by the amount counting unit as a reference amount for each jurisdiction area applied at the time of the initial setting, and the display control unit displays the reference amount on the setting screen.

In addition, in order to solve the aforementioned problems, the maintenance work support method of the present invention further includes: an amount collection step in which the computer collects information regarding an amount of money presented to a customer by the user as a cost of the maintenance work; and an amount counting step in which the computer counts the information regarding the amount of money collected by the amount collection step for each jurisdiction area. In the storage step, the information regarding the amount of money counted in the amount counting step is stored as a reference amount for each jurisdiction area applied at the time of the initial setting. In the display control step, the reference amount is displayed on the setting screen.

In addition, in order to solve the aforementioned problems, the maintenance work support program of the present invention causes the computer to further function as: an amount collection unit that collects information regarding an amount of money presented to a customer by the user as a cost of the maintenance work; and an amount counting unit that counts the information regarding the amount of money collected by the amount collection unit for each jurisdiction area. The storage unit stores the information regarding the amount of money counted by the amount counting unit as a reference amount for each jurisdiction area applied at the time of the initial setting, and the display control unit displays the reference amount on the setting screen.

In the maintenance work support apparatus, the maintenance work support system, the maintenance work support method, and the maintenance work support program of the present invention configured as described above, the amount of money calculated by collecting information regarding the amount of money (estimated amount or billed amount) presented to the customer by other users as a cost of maintenance work and averaging the information regarding the amount of money for each jurisdiction area is displayed on the initial setting screen as a reference amount. Therefore, even when there are regional differences or price fluctuations in the amount of money required for vehicle inspection or regular inspection and maintenance (the amount of money charged by the user to the customer for vehicle inspection or regular inspection and maintenance) and the user does not know the market price of the amount, the user can set an appropriate fee as a cost of the maintenance work.

### Advantageous Effects of Invention

According to the maintenance work support apparatus, the maintenance work support system, the maintenance work support method, and the maintenance work support program of the present invention, it is possible to reflect various conditions, regional differences, or price fluctuations according to user attributes so that the user can easily perform initial setting by himself or herself.

### BRIEF DESCRIPTION OF DRAWINGS

FIG. 1 is a configuration diagram showing the outline of a maintenance work support system including a maintenance work support apparatus.

FIG. 2 is a diagram showing the configuration of a maintenance work support apparatus from the functional aspect.

FIG. 3 is a flowchart showing the flow of a maintenance work support process.

FIG. 4 is a diagram showing an example of a screen displayed on an information terminal.

FIG. 5 is a diagram showing an example of a screen displayed on an information terminal.

FIG. 6 is a diagram showing an example of a screen displayed on an information terminal.

FIG. 7 is a diagram showing an example of a screen displayed on an information terminal.

FIG. 8 is a diagram showing an example of a screen displayed on an information terminal.

FIG. 9 is a diagram showing an example of a screen displayed on an information terminal.

FIG. 10 is a diagram showing an example of a screen displayed on an information terminal.

FIG. 11 is a diagram showing an example of a screen displayed on an information terminal.

FIG. 12 is a diagram showing an example of a screen displayed on an information terminal.

FIG. 13 is a diagram showing an example of a screen displayed on an information terminal.

FIG. 14 is a diagram describing the flow of regional average price setting.

### DESCRIPTION OF EMBODIMENTS

Hereinafter, an embodiment (hereinafter, the present embodiment) of the present invention will be described.

However, the embodiment described below is merely an example for facilitating the understanding of the present invention, and does not limit the present invention. That is, it is needless to say that the present invention can be modified and improved without departing from the spirit of the present invention and the present invention includes equivalents thereof.

### Outline of a Maintenance Work Support System According to the Present Embodiment

First, the schematic configuration of a maintenance work support system S including a maintenance work support apparatus (hereinafter, a server 1) will be described.

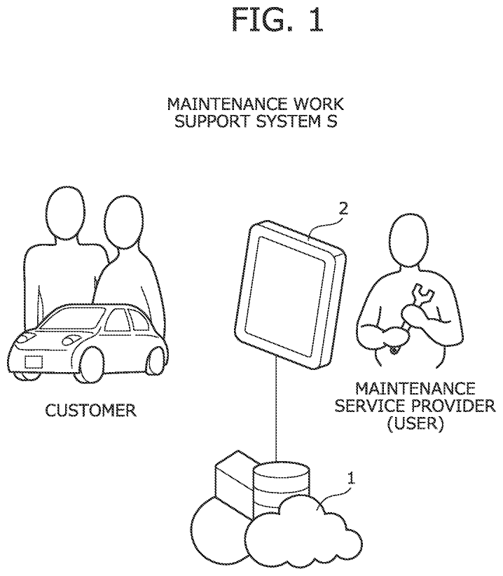

FIG. 1 is a configuration diagram showing the outline of the maintenance work support system S including the server 1.

As shown in FIG. 1, the maintenance work support system S of the present embodiment is configured to mainly include the server 1 and an information terminal 2, and these are connected to each other through a communication line that is a communication network.

The server 1 is included in the maintenance work support system S shown in FIG. 1, and is used by, for example, a maintenance service provider (hereinafter, referred to as a user), such as an automobile maintenance shop or an automobile dealer that provides maintenance services including inspections of vehicles or parts of automobiles to customers, and an administrator who performs maintenance, management, operation, and the like of the maintenance work support system S and provides the user with a service based on the maintenance work support system S (hereinafter, referred to as maintenance work support service).

The server 1 is a server computer owned or managed by an administrator or the like who is a maintenance work support service provider. Then, the user can enjoy the functions or services provided by the server 1 through the communication line. That is, the user communicates with the server 1 by operating each information terminal 2, thereby using the function of the server 1. In addition, the server 1 is not limited to one constructed by one server apparatus, and may be constructed by using a plurality of server apparatuses.

In addition, the details of the server 1 will be described later.

The information terminal 2 is a computer owned and operated by the user. The information terminal 2 includes a data transmission unit and a reception unit for enabling transmission and reception of data, a display unit such as a display for displaying the data, and an input unit for receiving an input (including the case of selection from a plurality of options) by the user, so that the server 1 and the information terminal 2 can transmit and receive data to and from each other through the communication line.

In addition, the information terminal 2 is not particularly limited as long as the information terminal 2 has at least an input function for inputting, creating, and changing data and the like and has a data transmission unit and a reception unit for enabling transmission and reception of data and a display unit for displaying the received data and the like, and smartphones, tablet terminals, desktop personal computers, laptop personal computers, mobile phones, game machines, and the like can be used.

The communication line is, for example, a mobile network such as the Internet, 3G, 4G, or LTE, and connects the server 1, the information terminal 2, other external services, and an external database so as to be able to communicate with each other.

In addition, although only one information terminal 2 is connected in FIG. 1, it is assumed that a plurality of information terminals 2 are connected according to the number of users in practice. In addition, other servers and information terminals may be connected to each other.

<Detailed Configuration of a Maintenance Work Support Apparatus (Server)>

Next, the detailed configuration of the server 1 will be described.

The server 1 has, as its components, at least a CPU as a calculation unit that performs control or calculates and processes data, a ROM as a read-only storage device, a RAM as a main memory (main storage device), a communication interface for transmitting and receiving data to and from an external apparatus communicable through the communication line, and a hard disk drive as an auxiliary storage device.

The server 1 of the present embodiment uses a cloud service method, and is configured by connecting respective servers having distributed roles, such as a virtual server, a processing server, a management server, and various database servers, so as to be able to communicate with each other on the web.

In addition, on the server 1, a program for realizing its function (hereinafter, referred to as a maintenance work support program) is installed. When the maintenance work support program is read and executed by the CPU, the function as a maintenance work support apparatus is realized.

Here, the function of the server 1 is enjoyed by the user, the administrator, and the like, and the method of providing the function to the user and the like may be, for example, an ASP service. In addition, the database server may be configured as a separate body. In addition, it is preferable to perform system backup and database backup as appropriate.

The hardware configuration of the server 1 is as described above, but the configuration of the server 1 will be described again from the functional aspect.

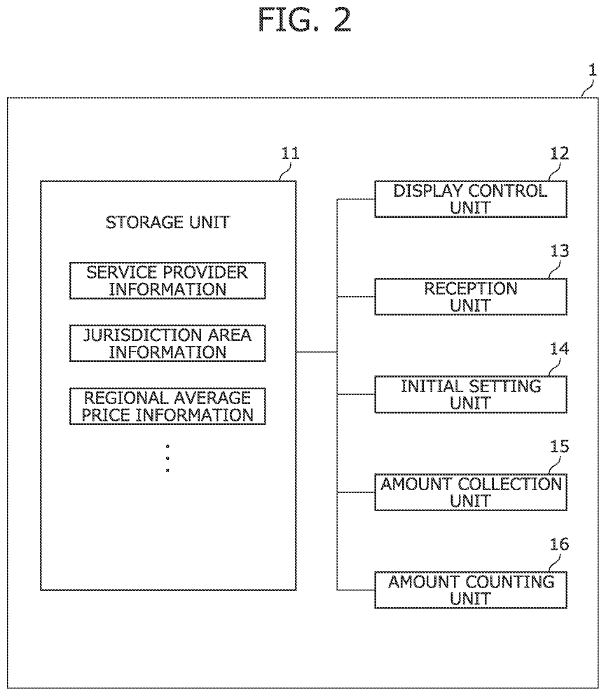

FIG. 2 is a diagram showing the configuration of the maintenance work support apparatus from the functional aspect.

As shown in FIG. 2, the server 1 includes, as its main components, a storage unit 11, a display control unit 12, a reception unit 13, an initial setting unit 14, an amount collection unit 15, and an amount counting unit 16.

The storage unit 11 is a hard disk drive (or may be an external database server).

In the storage unit 11, in addition to basic information such as the user's name, address, and contact information, factory classification, Transport Bureau certification number, Transport Bureau designated number, automobile inspection and registration office, accounting information such as closing date or beginning month, and service provider information including information regarding holidays are stored.

In addition, jurisdiction area information including basic information such as the name, address, and contact information of the jurisdiction area (transportation branch office or automobile inspection and registration office) or information, such as the format of application documents specified for each jurisdiction area, is stored. In addition, the amount of money calculated by collecting information regarding the amount of money (estimated amount or billed amount) presented to the customer by a plurality of users as a cost of maintenance work and averaging the information regarding the amount of money for each jurisdiction area, that is, regional average price information corresponding to the reference amount, is stored for each item such as service content or parts.

The display control unit 12 displays an initial setting screen including initial setting items in an interactive format (wizard format) on a display unit such as a display of the information terminal 2.

The reception unit 13 receives an instruction signal input by the user on the initial setting screen displayed on the information terminal 2 through the communication line.

The initial setting unit 14 specifies the jurisdiction area for each user according to the instruction signal received by the reception unit 13, extracts jurisdiction area information corresponding to the specified jurisdiction area from the storage unit 11, and sets the extracted jurisdiction area information as service provider information indicating the user.

The amount collection unit 15 collects information regarding the amount of money, which is presented to the customer by estimation, billing, or the like as a cost of maintenance work for each user, from a plurality of users.

The amount counting unit 16 calculates the reference amount by counting, for example, averaging the information regarding the amount of money collected by the amount collection unit 15 for each jurisdiction area.

These functional units are responsible for various processes executed by the server 1, and are configured by cooperation between the above-described hardware component devices forming the server 1 and the above-described maintenance work support program.

<Maintenance Work Support Method>

Next, a maintenance work support method according to the present embodiment will be described.

The maintenance work support method according to the present embodiment is realized by using the server 1 that functions as a computer. In other words, the maintenance work support method according to the present embodiment is applied to the maintenance work support process executed by the server 1.

The flow of the maintenance work support process (initial setting process) executed by the maintenance work support system S will be described.

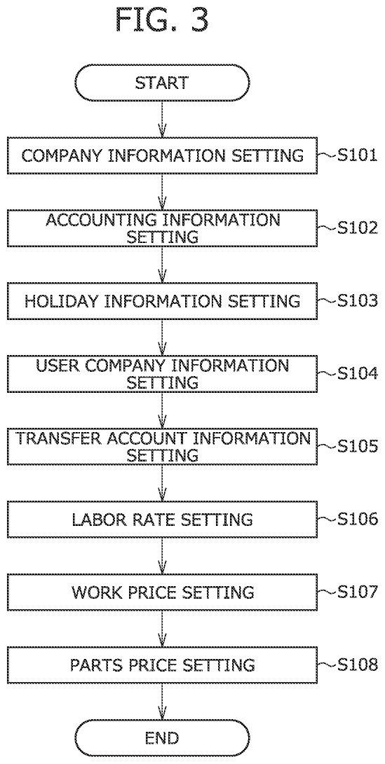

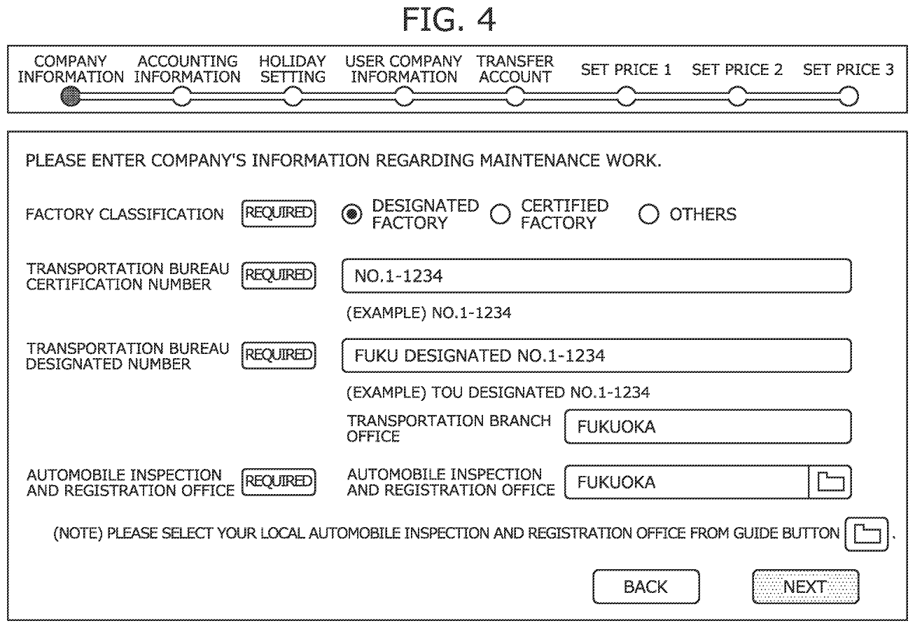

FIG. 3 is a flowchart showing the flow of the maintenance work support process executed in the maintenance work support system S. FIGS. 4 to 13 are diagrams showing examples of a screen displayed on the information terminal 2 in each step of the maintenance work support process.

The maintenance work support process proceeds as shown in FIG. 3. The server 1 causes the information terminal 2 to display a company information setting screen (S101), causes the information terminal 2 to display an accounting information setting screen (S102), and causes the information terminal 2 to display a holiday information setting screen (S103). Then, a user company information setting screen is displayed on the information terminal 2 (S104), and a transfer account information setting screen is displayed on the information terminal 2 (S105). In addition, a labor rate setting screen is displayed on the information terminal 2 (S106), a work price setting screen is displayed on the information terminal 2 (S107), a parts price setting screen is displayed on the information terminal 2 (S108), and the process ends.

Hereinafter, each of the above steps will be specifically described with reference to the screen displayed on the information terminal 2.

As shown in FIG. 4, on the company information setting screen corresponding to S101, the user first selects his or her factory classification from designated factory, certified factory, and others. In addition, the user inputs the transportation bureau certification number and the transportation bureau designated number. On the other hand, the automobile inspection and registration office (including the transportation branch office) is automatically selected based on the address registered in advance by the user at the time of system contract. The information set herein is an initial selection value at the time of vehicle registration or issuance of application documents, so that it is possible to save the trouble of inputting.

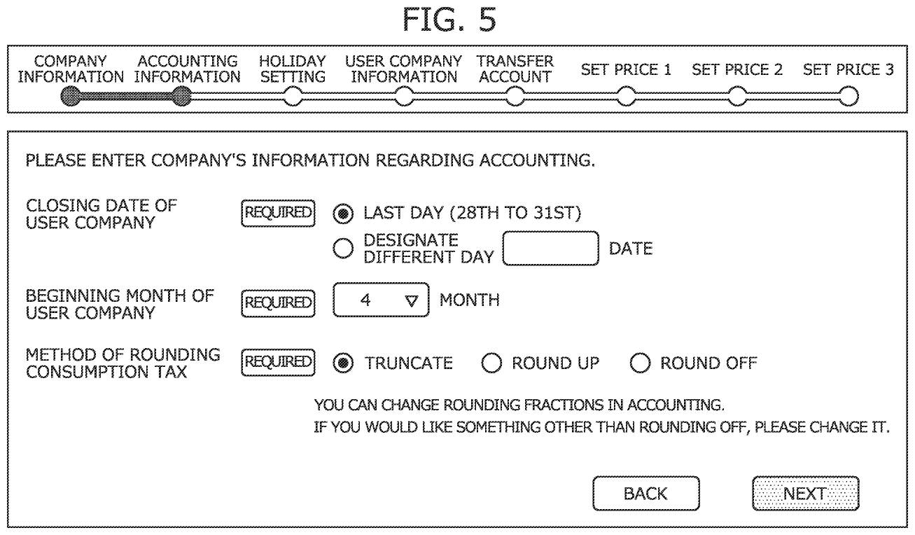

In addition, when the input is completed, a “next” button is clicked to move to the next screen (hereinafter, the same applies to the setting screens of FIGS. 5 to 12).

As shown in FIG. 5, on the accounting information setting screen corresponding to S102, the user selects or inputs the closing date of the user company, the beginning month of the user company, and the method of rounding the consumption tax. In this manner, here, the user makes the minimum necessary settings related to the user company's accounting. By setting those described above in advance herein, it is possible to start the work without having to make the settings in the master maintenance.

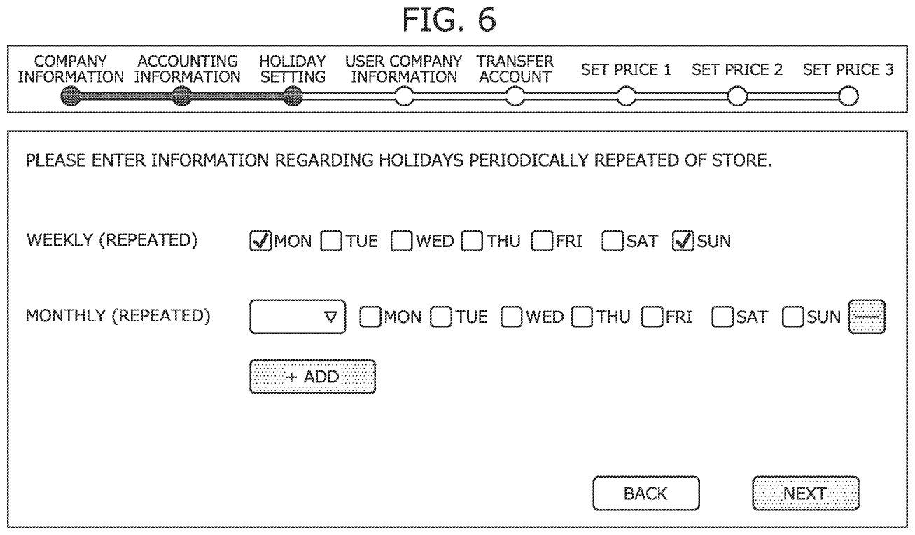

As shown in FIG. 6, on the holiday setting screen corresponding to S103, the user selects or inputs information regarding holidays (weekly, monthly) that are periodically repeated. In addition, it is also possible to add a holiday for each day. In this manner, here, the user sets his or her company's holidays. A dedicated calendar is created based on the information set herein and displayed on the reception screen.

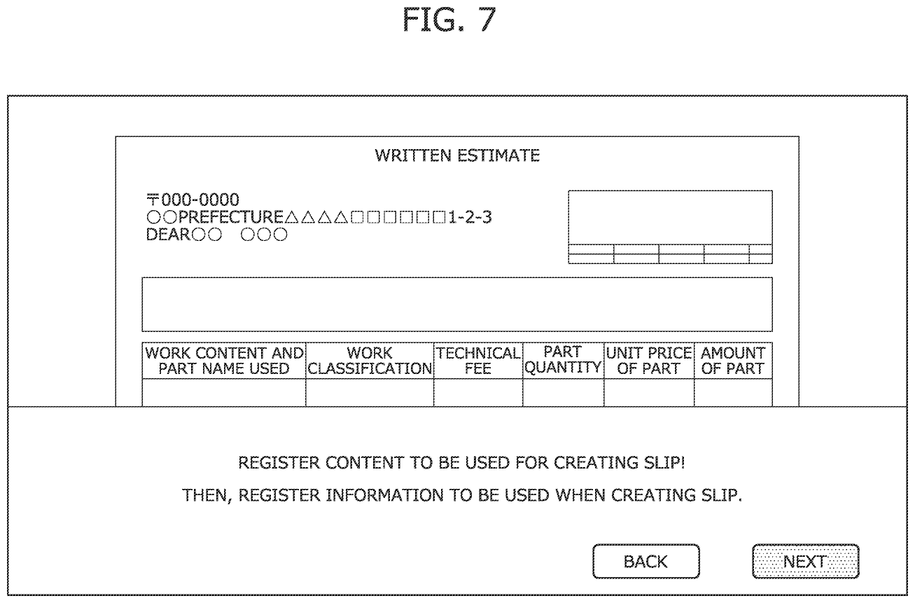

Then, when the input of the basic information up to this point is completed, as shown in FIG. 7, the screen transitions to a screen for setting the registration of the content to be used for slip creation (printing).

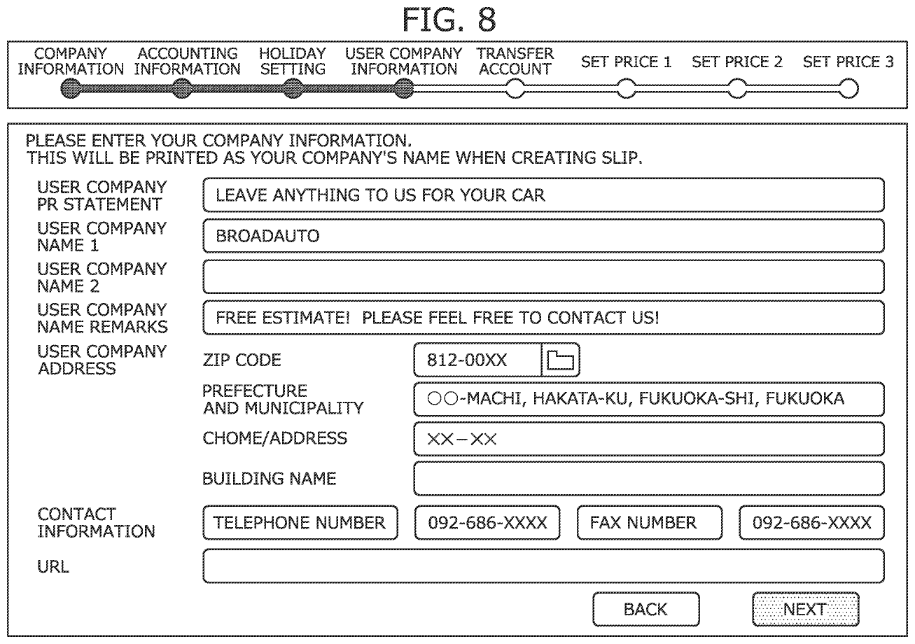

As shown in FIG. 8, on the user company information setting screen corresponding to S104, the user selects or inputs and registers various kinds of information printed on the slip as user company information at the time of slip creation, such as a user company PR statement, a user company name, user company name remarks, a user company address, contact information (telephone number, FAX number), and URL. In addition, some of the information, such as the user company name or the user company address, are initially displayed by reflecting the content registered in advance by the user at the time of system contract or the like.

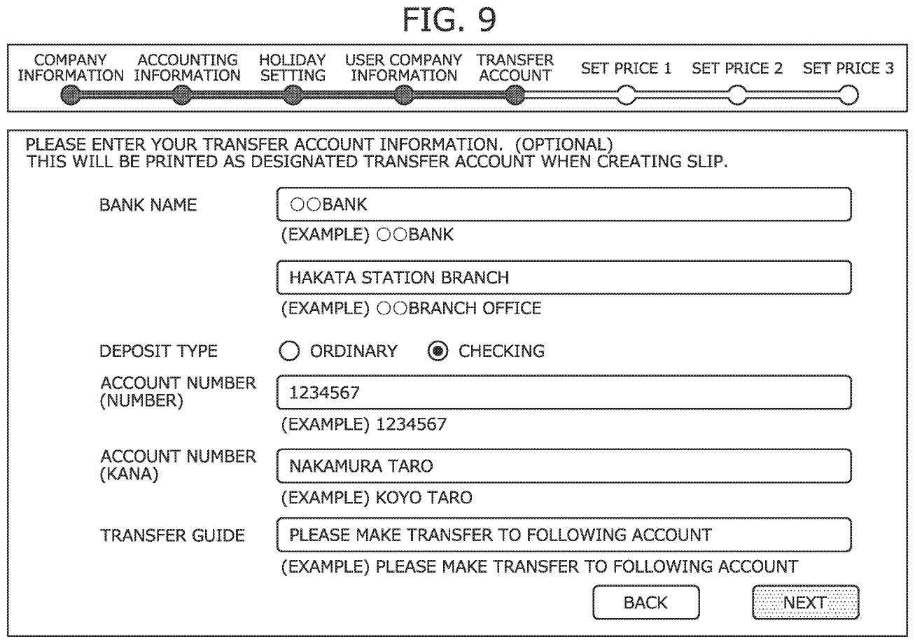

As shown in FIG. 9, on the transfer account information setting screen corresponding to S105, the user selects or inputs and registers account information, such as a bank name, a deposit type, an account number, an account name, and a transfer guide. The information set herein is printed on the slip as transfer destination account information.

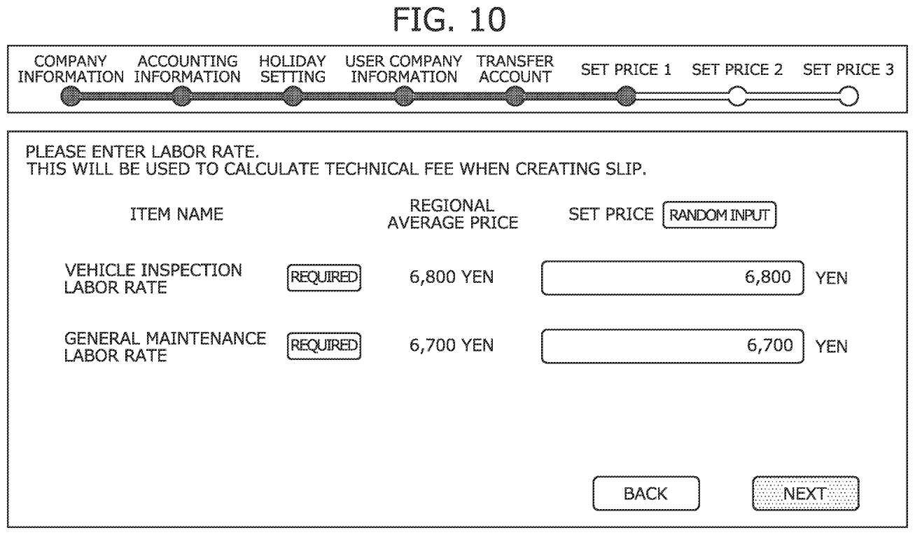

As shown in FIG. 10, on the labor rate setting screen corresponding to S106, the user can set the labor rate (wage unit price) in advance. Specifically, the user selects or inputs a vehicle inspection labor rate and a general maintenance labor rate. Here, as a reference price, the market price of the labor rate corresponding to the area according to the user company's address, that is, a “regional average price” is displayed in the left column portion. The user can set the labor rate of his or her company in the right column portion by referring to the “regional average price” in the image of referring to a general price list. That is, it is possible to easily carry out pricing considering the average price in the area. It is also possible to post the “regional average price” to the “set price” by pressing the “random input” button. The price set herein is used to calculate the technical fee, and is automatically reflected when the slip is created.

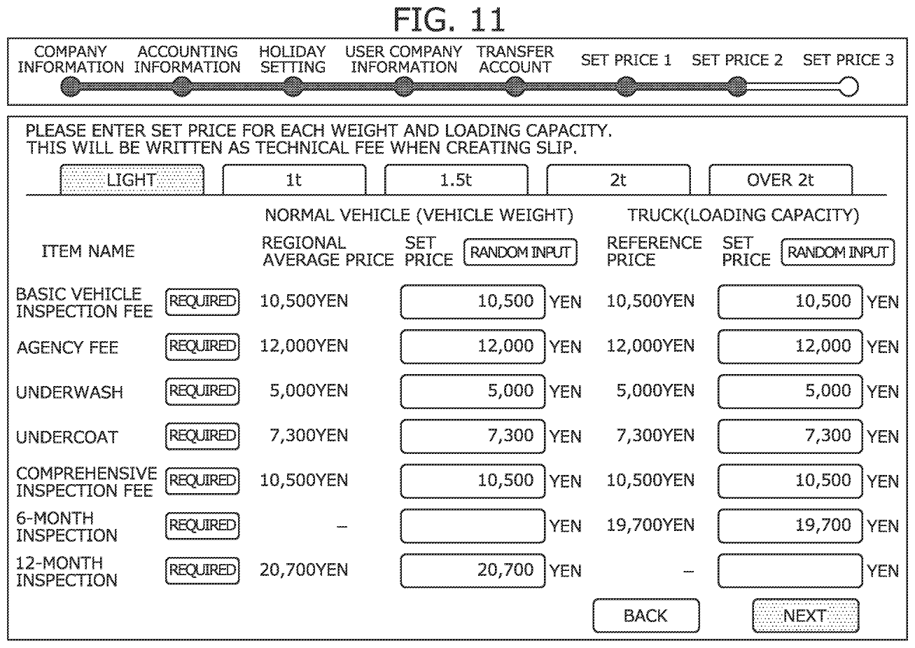

As shown in FIG. 11, on the work price setting screen corresponding to S107, the user can set a typical work price in advance for each vehicle type. For example, the user selects or inputs the price of basic vehicle inspection fee, agency fee, underwash, undercoat, comprehensive inspection fee, 6-month inspection, 12-month inspection, and the like for each vehicle type (light, 1 t, 1.5 t, 2 t, over 2 t). Here, as a reference price, the market price of each work price corresponding to the area according to the user company's address, that is, a “regional average price” is displayed in the left column portion. The user can set each work price of his or her company in the right column portion by referring to the “regional average price” in the image of referring to a general price list. It is also possible to post the “regional average price” to the “set price” by pressing the “random input” button. The price set herein is used to calculate the technical fee, and is automatically reflected when creating the slip.

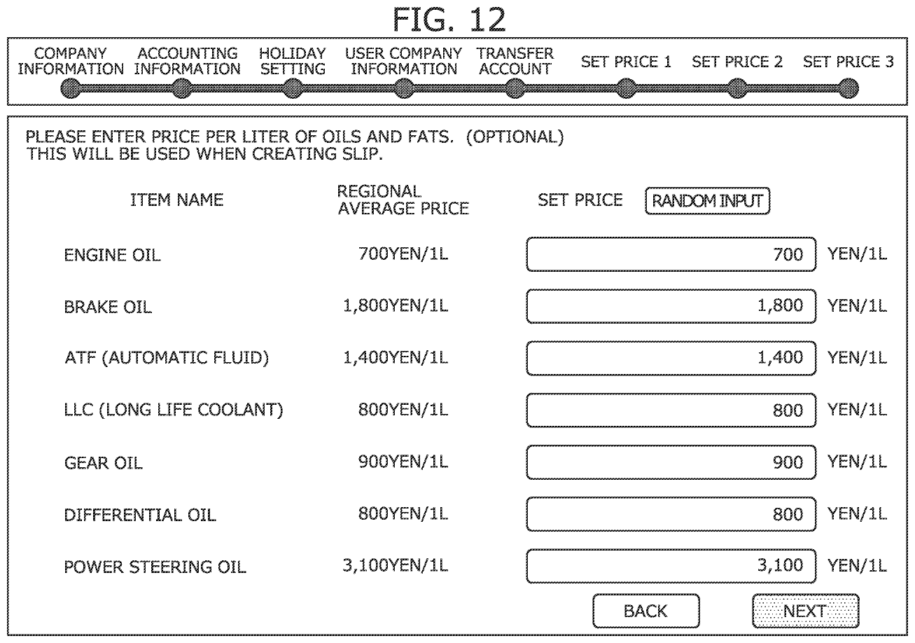

As shown in FIG. 12, on the parts price setting screen corresponding to S108, the user can set a typical parts price in advance. For example, the user selects or inputs the price per liter of oils and fats, such as engine oil, brake oil, ATF, LLC, gear oil, differential oil, and power steering oil. Here, as a reference price, the market price of each part corresponding to the area according to the user company's address, that is, a “regional average price” is displayed in the left column portion. The user can set each part price of his or her company in the right column portion by referring to the “regional average price” in the image of referring to a general price list. It is also possible to post the “regional average price” to the “set price” by pressing the “random input” button. The price set herein is automatically reflected when the slip is created.

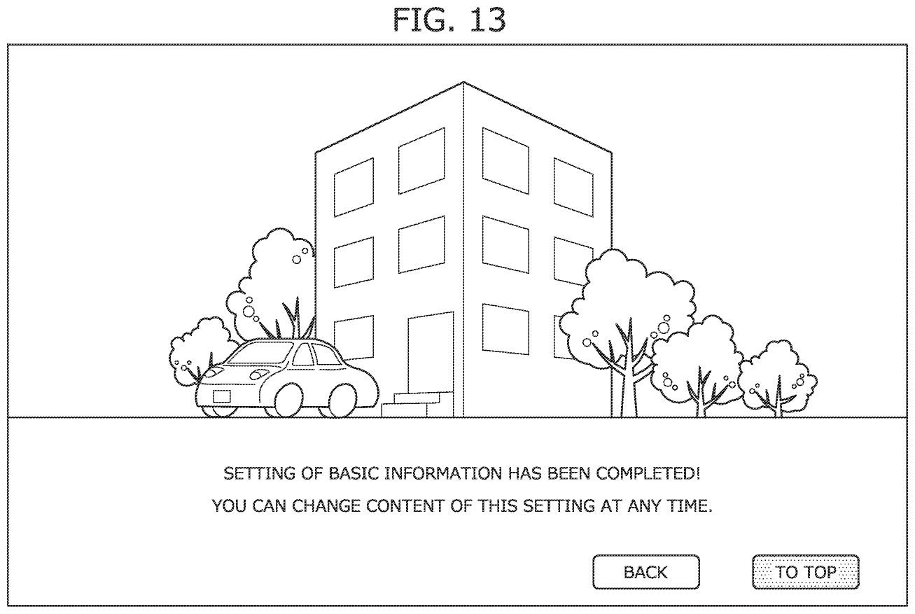

As described above, when all the inputs for the initial setting items are completed, finally, as shown in FIG. 13, the screen transitions to a screen showing the completion of the setting to end the process. In addition, the content entered on each screen can be modified or changed at any time later.

On each of the screens described above, a bar showing the progress is displayed at the top of the screen so that the stage at which the initial setting is currently progressing can be seen at a glance.

In addition, on each of the screens described above, a character (not shown) acting as a navigator may appear to prompt the user to input the initial setting items using characters, voice, or the like. In addition, if a question is asked about an unclear point, the character may answer the user.

Next, the setting of the regional average price as a reference amount will be described.

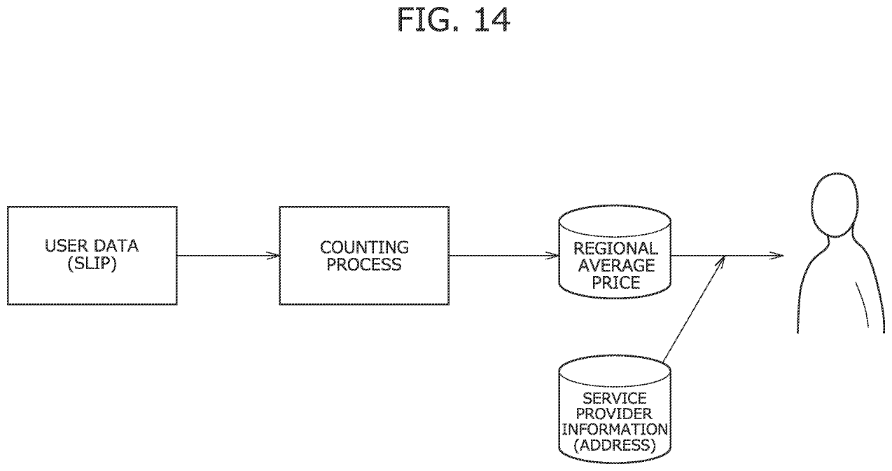

FIG. 14 is a diagram describing the flow of regional average price setting.

As shown in FIG. 14, the regional average price is calculated by collecting the amount of money, which is presented to the customer by estimation, billing, or the like as a cost of maintenance work for each user, from a plurality of users and counting, for example, averaging the pieces of information for each jurisdiction area. Then, the local work price or the local average price of the part price according to the service provider information is provided to the corresponding user. In addition, the data referred to herein is collected excluding the personal information of the user, and counted for each vehicle type or region. In addition, the regional average price maybe recounted at regular intervals, or may be updated in real time so that the latest information can always be referred to.

As described above, the maintenance work support system S of the present embodiment is characterized in that the initial setting items are displayed interactively (wizard format) on the initial setting screen and that the amount of money can be set by referring to the regional average price.

In the former point, if the user answers the questions asked by the wizard after purchasing the system, the settings are completed by answering only the most suitable questions for the user, and the system is ready for use. Therefore, for example, questions can be selected according to the type of factory, target business, purchased options, and the like, and can be set in a short time by narrowing down only the questions required for the target user in a question format. In addition, it is possible to process the content entered in a question format and make necessary settings to start the work. In addition, the transportation branch office or the like is initially selected based on the address registered at the time of contract, so that it is possible to save the trouble of inputting by the user. In addition, when creating a new application document, the transportation branch office or the like can be initially displayed based on the license plate of the vehicle.

In the latter point, since the regional average value of each product (work, part) that users use in their daily work is provided, regional averaging, that is, pricing of products (work, parts) considering competition can be performed. In particular, the regional average price can be displayed on the initial setting screen based on the user company's address. Therefore, by setting the products (work, parts) based on the regional average price, the price set when creating the sales slip is automatically reflected. As a result, work efficiency is improved. In addition, prices that fluctuate with crude oil prices or the like can be reviewed in a timely manner.

<Others>

Until now, examples of the maintenance work support apparatus, the maintenance work support system, the maintenance work support method, and the maintenance work support program according to the present invention have been described. However, the above-described embodiment is merely one of the specific configurations of the present invention, and other configuration examples or application examples can also be considered.

For example, although the jurisdiction area (transportation branch office or automobile inspection and registration office) is automatically selected based on the information such as the address of the user registered in advance in the present embodiment, the jurisdiction area (transportation branch office or automobile inspection and registration office) may be automatically selected from the information such as the vehicle number.

In addition, the reference amount is not limited to the regional average price for each jurisdiction area, but may be an average value in a wider area such as the Kanto region or the Kyushu region, or the national average value or the like may be referred to. In addition, the reference amount is not limited to a simple average value, and the dispersion status may be displayed as a graph.

### REFERENCE SIGNS LIST

1: SERVER (MAINTENANCE WORK SUPPORT APPARATUS)
2: INFORMATION TERMINAL
11: STORAGE UNIT
12: DISPLAY CONTROL UNIT
13: RECEPTION UNIT
14: INITIAL SETTING UNIT
15: AMOUNT COLLECTION UNIT
16: AMOUNT COUNTING UNIT
S: MAINTENANCE WORK SUPPORT SYSTEM

1. A maintenance work support apparatus for supporting maintenance work of a vehicle or a part of an automobile, comprising:
a storage unit that stores a jurisdiction area corresponding to attributes of a user and an application document format for each jurisdiction area;
a display control unit that displays a setting screen including initial setting items;
a reception unit that receives an input operation of the user on the setting screen; and
an initial setting unit that selects the jurisdiction area according to the input operation of the user received by the reception unit and performs initial setting for each user,
wherein the display control unit interactively displays the initial setting items to instruct the user to perform input operations in a predetermined order.

2. The maintenance work support apparatus according to claim 1, further comprising:
an amount collection unit that collects information regarding an amount of money presented to a customer by the user as a cost of the maintenance work; and
an amount counting unit that counts the information regarding the amount of money collected by the amount collection unit for each jurisdiction area,
wherein the storage unit stores the information regarding the amount of money counted by the amount counting unit as a reference amount for each jurisdiction area applied at the time of the initial setting, and
the display control unit displays the reference amount on the setting screen.

3. A maintenance work support system for supporting maintenance work of a vehicle or a part of an automobile, comprising:
a server; and
an information terminal communicatively connected to the server,
wherein the server or the information terminal includes:
a storage unit that stores a jurisdiction area corresponding to attributes of a user and an application document format for each jurisdiction area;
a display control unit that displays a setting screen including initial setting items;
a reception unit that receives an input operation of the user on the setting screen; and
an initial setting unit that selects the jurisdiction area according to the input operation of the user received by the reception unit and performs initial setting for each user, and
the display control unit interactively displays the initial setting items to instruct the user to perform input operations in a predetermined order.

4. The maintenance work support system according to claim 3,
wherein the server or the information terminal further includes:
an amount collection unit that collects information regarding an amount of money presented to a customer by the user as a cost of the maintenance work; and
an amount counting unit that counts the information regarding the amount of money collected by the amount collection unit for each jurisdiction area,
the storage unit stores the information regarding the amount of money counted by the amount counting unit as a reference amount for each jurisdiction area applied at the time of the initial setting, and
the display control unit displays the reference amount on the setting screen.

5. A maintenance work support method for supporting maintenance work of a vehicle or a part of an automobile by a computer, comprising:
a storage step in which the computer stores a jurisdiction area corresponding to attributes of a user and an application document format for each jurisdiction area;
a display control step in which the computer displays a setting screen including initial setting items;
a reception step in which the computer receives an input operation of the user on the setting screen; and
an initial setting step in which the computer selects the jurisdiction area according to the input operation of the user received in the reception step and performs initial setting for each user,
wherein, in the display control step, the initial setting items are interactively displayed to instruct the user to perform input operations in a predetermined order.

6. The maintenance work support method according to claim 5, further comprising:
an amount collection step in which the computer collects information regarding an amount of money presented to a customer by the user as a cost of the maintenance work; and
an amount counting step in which the computer counts the information regarding the amount of money collected by the amount collection step for each jurisdiction area,
wherein, in the storage step, the information regarding the amount of money counted in the amount counting step is stored as a reference amount for each jurisdiction area applied at the time of the initial setting, and
in the display control step, the reference amount is displayed on the setting screen.

7-8. (canceled)
